(19) United States
(12) Patent Application Publication
(10) Pub. No.: US 2022/0202038 A1
(43) Pub. Date: Jun. 30, 2022

(54) PLANT-BASED MEAT ANALOGUE WITH MUSCLE-LIKE FIBERS

(71) Applicant: The Livekindly Company Switzerland GmbH, Pfäffikon (CH)

(72) Inventors: Achim Knoch, Minden (DE); Julie Daoust, Los Angeles, CA (US)

(21) Appl. No.: 17/513,678

(22) Filed: Oct. 28, 2021

Related U.S. Application Data
(60) Provisional application No. 63/132,335, filed on Dec. 30, 2020.

(51) Int. Cl. A23J 3/22; A23J 3/26; A23L 5/10; A23L 3/36

(52) U.S. Cl. CPC A23J 3/225; A23L 3/36; A23L 5/19; A23J 3/26

(57) ABSTRACT

In some embodiments, the present technology is directed to a plant-based meat analogue produced by the process comprising: shearing a texturized product to allow the ingress of fluids; adding the texturized product to a salt solution; and heating the texturized product in the salt solution for one or more predetermined time-periods at one or more predetermined temperature ranges. Additionally, the salt solution may comprise other ingredients. In some embodiments, the texturized product is further heated in a second solution for a second set of one or more predetermined time-periods at one or more predetermined temperature ranges. In some embodiments, the process further comprises centrifugation of the cooked texturized product.

### CROSS-REFERENCE TO RELATED APPLICATIONS

The present application claims the priority benefit of U.S. Provisional Patent Application Ser. No. 63/132,335 filed on Dec. 30, 2020 and titled “Plant-Based Meat Analogue with Muscle-Like Fibers,” which is hereby incorporated by reference in its entirety.

### FIELD OF INVENTION

The present technology pertains to plant-based meat alternatives and analogues and methods for their production and manufacture. In particular, but not by way of limitation, the present application provides a plant-based meat analogue with muscle-like fibers.

### SUMMARY

In some embodiments the present technology is directed to a plant-based meat analogue produced by the process comprising: shearing a texturized product to allow the ingress of fluids; adding the texturized product to a salt solution; and heating the texturized product in the salt solution for one or more predetermined time-periods at one or more predetermined temperature ranges. Additionally, the salt solution may comprise other ingredients. In some embodiments, the texturized product is further heated in a second solution for a second set of one or more predetermined time-periods at one or more predetermined temperature ranges. In some embodiments, the process further comprises centrifugation of the cooked texturized product. In various embodiments, the texturized product is limited to a high moisture extrudate (“extrudate mixture”) that egresses a high moisture extrusion process.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1. is a summarized diagrammatical representation of a high moisture extrudate extrusion process (HME).

FIG. 2 is a detailed diagrammatical representation of one version of the processes surrounding an HME extrusion process, including pre-and-post processing steps.

FIG. 3 is a detailed diagrammatical representation of another version of the processes surrounding an HME extrusion process, including pre-and-post processing steps.

FIG. 4. is a flow-chart diagram of the post-processing steps to create meat analogues with muscle-like fibers.

### DETAILED DESCRIPTION

The approaches described in this section could be pursued but are not necessarily approaches that have previously been conceived or pursued. Therefore, unless otherwise indicated, it should not be assumed that any of the approaches described in this section qualify as prior art merely by virtue of their inclusion.

Meat analogues and meat alternative products made out of plant proteins (including also protein enriched flours, concentrates and isolates) and plant products are gaining in popularity, this is due to a variety of factors including increased environmental consciousness; specifically the effects the meat industry is known to have on climate, and increased health consciousness in the general population and the promotion of low cholesterol, low fat protein alternatives.

However, in their current state, meat analogues, meat alternatives and plant-based foods and proteins may suffer from several disadvantages and shortcomings relative to natural meat. Some obvious disadvantages and shortcomings of current alternative meat products are their taste and texture, which are different from and fail to replicate the taste and texture of natural meats, these alternatives also fail to resemble meats in color and other physical aspects. Finally, affordability and wide availability of these meat analogues and plant proteins are a challenge since producing meat alternatives are much costlier and more difficult than industrial scale meat production.

Therefore, in the field of meat analogue or meat alternative manufacturing processes, it is generally accepted that there are several goals that the final meat analogue product and the manufacturing process itself must meet; these include alternative meat products that are desirable to the senses, tasty and affordable. More specifically, the alternative meat products should have a texture very similar to that of natural meats, including, but not limited to, poultry, beef, and pork. A meat-like texture allows the bite or crunch of a meat analogue product to feel like that of natural meats to the consumer. Other goals are for the meat analogue to taste like and have the same color and/or physically resemble natural meats. Another very important goal is for the process of making the meat analogue product to be scalable, highly efficient, and largely free from manufacturing defects and disruptions. Production line efficiency allows the meat analogue to be affordable and widely available as a reasonable and realistic alternative to animal proteins to the general population.

To realize these goals, the meat analogue industry has moved towards a High Moisture Extrudate (HME) extrusion process that includes shearing. It is generally accepted that the HME extrusion process involves several standardized steps, these steps may be modifiable, altered, added to, or removed depending on the mixtures, recipes and ingredients used as well as the desired product outcome. However, the standard process includes feeding and conveying ingredients into an extruder, mixing, heating and melting the extrudate mixture and compressing the mixture and then to achieve and/or maintain the desired meat-like texture, to press the extrudate mixture into a cooling die which further cools and structures the mixture. Post-processing steps may also be added after the HME extrusion process after the cooling die which may include cutting and shearing the protein, or more typically after the extrudate mixture leaves the cooling die, and these steps may include cutting, shearing, cooking, freezing, storing, or adding flavors, fats and other food manufacturing and culinary additives as described in this document.

A texturized product, or in other embodiments an extrudate mixture that is fed into and/or is created in an extruder may be comprised of any food manufacturing ingredient including and not limited to plant proteins, soy or pea proteins, e.g. concentrates or isolates, plant protein concentrates, protein isolates, meat proteins and compositions, animal milk proteins and protein products and concentrates, as well as additives such as flavor enhancers, preservatives, PH agents, color additives, fats, bonding agents and compositions, salts as well water, other solutions and liquids. The extrudate mixture may be pre-mixed before feeding into the extruder or separate components may be added individually into the extruder, or a combination of both.

In the analogue meat industry, the texture of the texturized product or an extrudate mixture ideally should have long meat-like fibers in parallel that are placed on top of each other. One way to achieve a meat-like texture is by having a laminar flow of an extrudate mixture in the cooling die of an HME extrusion process, whereby the flow of the mixture is such that a pattern resembling a half moon shape is created. This pattern is a similar pattern to what is found in natural meats. Furthermore, a thickness up to 18 mm (and beyond in special applications) is ideal since it resembles the thickness of natural meats like that of a steak or a chicken breast. These two components, plant-based meat analogue fiberization as well as the thickness of meat analogues together create a realistic culinary meat-eating experience.

Generally, after the HME extrusion process the extrudate mixture is cut or sheared to determine the shape and size of the final product and to allow the ingress and uptake of moisture by the extrudate and then cooked in water for around 20 mins to increase juiciness, creating a meat-like feel to the bite as part of a series of post-processing steps. However, cooking in water softens the extrudate, and the longer the extrudate is cooked in water, the softer it gets, losing its meat like fiberization that was produced in the extruder and cooling die portions of the HME extrusion process.

In various embodiments, the current technology is directed to creating a meat-like texture, that resembles whole muscle fibers in animal meat products, by heating a texturized product (or in some embodiments an extrudate mixture) in a salt solution. Heating a texturized product or an extrudate mixture in a salt solution ensures that the softening effect created by cooking/heating in water does not occur, while the texturized product or extrudate mixture is still able to achieve the desired ‘juiciness’ due to the ingress of water into the product, and still retaining the meat-like texture in the product. While not limited to the HME extrusion process, in various embodiments, the processes taught in this application are applied to extrudate material/an extrudate mixture that comes out of the cooling die as part of an HME extrusion process. In other embodiments, the processes taught are applied to a texturized plant-based product created by any other process, including but not limited to an HME extrusion process.

In several embodiments the texturized product, or alternatively, the HME/extrudate mixture is made up of 1-part soy proteins concentrates and/or isolates and 2-parts water, or primarily 1-part soy proteins concentrates and/or isolates and 2-parts water with other additives. Other combinations of plant proteins concentrates and isolates and other plant based materials may also be used. Additionally, other combinations of protein and water are possible.

In various embodiments a meat-like texture is created by processing the extrudate mixture coming out of the HME extrusion process. First the extrudate is sheared and/or cut, whereby several cuts are made in the extrudate mixture, by a cutter and/or by feeding the extrudate into a roller mill. Optionally, the extrudate mixture may be placed in a salt solution (preferably comprised primarily of water and a salt), then the mixture in the solution is heated up for a predetermined time-period at predetermined temperatures.

In several embodiments, a meat-like texture can be created in the plant-based extrudate mixture by processing the extrudate mixture coming out of the HME extrusion process. First the extrudate is sheared and/or cut, whereby several cuts are made in the extrudate mixture, by a cutter and/or by feeding the extrudate into a roller mill. Then the extrudate mixture is placed in a salt solution (preferably comprised primarily of water and a salt), then the mixture in the solution is cooked for 20-25 minutes in a cooking tumbler or other suitable cooking apparatus, which could work batch wise or continuously. Afterwards a second heating step at a temperature not higher than 85° Celsius (185° F.). Preferably the extrudate mixture that is placed in the salt solution is primarily composed of 1-part soy protein and 2-parts water (it may have had other ingredients or additives added to it during the HME process). However other plant-based mixtures and plant-based proteins and HMEs may also be used.

In some embodiments, a plant-based meat-like texture can be made by processing the extrudate mixture coming out of the HME extrusion process. First the extrudate is sheared, whereby several cuts are made, by a cutter or by feeding the extrudate into a roller mill. In some embodiments, the extrudate is coated with salt and allowed to sit (the time for allowing the mixture to sit varies depending on the thickness and composition of the extrudate mixture), and then the mixture is heated in water for 20-25 minutes. Preferably cooking is done at temperatures up to 100° Celsius. Preferably the extrudate mixture that is placed in the salt solution is primarily composed of 1-part soy protein and 2-parts water (it may have had other ingredients or additives added to it during the HME extrusion process). However other plant-based mixtures and plant-based proteins and HMEs may also be used.

In various embodiments, shearing is carried out during the HME extrusion process in the extruder to prepare the hot melted proteins for building a fibrous matrix in the cooling die. After excretion of the extrudate mixture from the cooling die, the extrudate mixture is cut, for example by a fixed cutting grid at the outlet of the cooling die. A second shearing of the texturized product out of the cooling die can also be carried out either before or after the cutting step after the extrudate mixture is excreted from the cooling die. This second shearing step allows the opening of the fibrous structure of the extrudate mixture or texturized product. In various embodiments, the cooking temperature may vary throughout the cooking process, and differ at different timepoints of the cooking process.

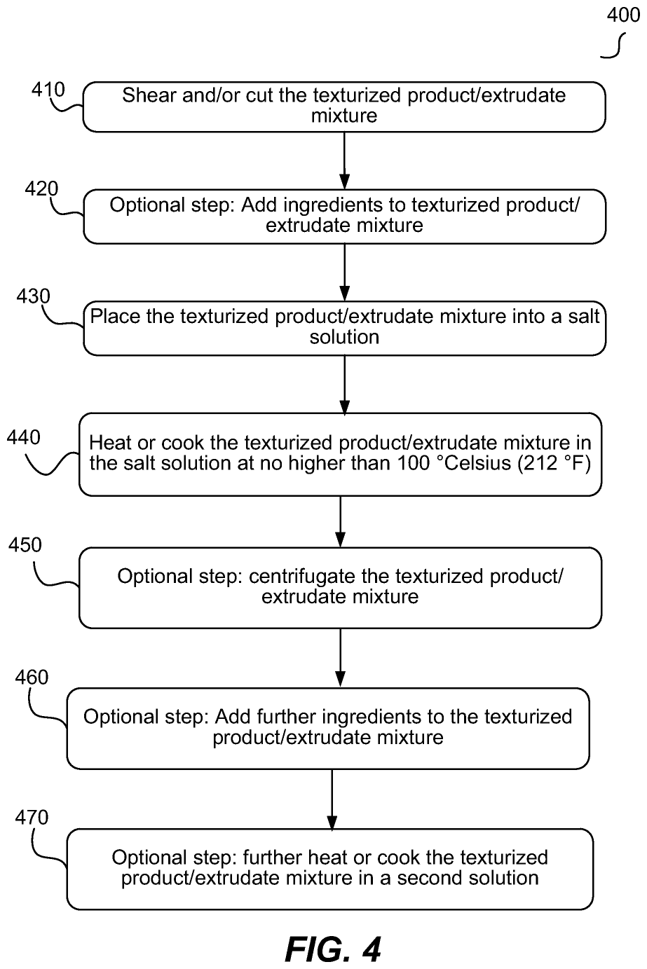

In various embodiments, as the extrudate mixture is excreted out of the cooling die outlet, it is allowed to cool down and slightly harden for an optimal period of time and reach an optimal temperature. Once it reaches the optimal temperature, it is sheared, for example by rolling drums or millings. In some embodiments, once it is sheared at the optimal temperature, it can be cooked in a salt solution, and/or go through the series of steps and processes mentioned in this document (for example the series of steps as listed in FIG. 4).

In some embodiments, the texturized product or extrudate mixture is cooked in a solution, for a set period of time, then taken out and cooked in a different solution. One example is initial cooking in a salt solution and then taking the extrudate mixture out and cooking it in a water based no-salt solution. In some embodiments a certain amount of time must pass while cooking in the salt solution before taking the extrudate out and cooking it in a water solution for another period. In various embodiments, initial cooking and/or heating is carried out in a salt solution, then the texturized product or extrudate mixture goes through or is placed in a centrifugation step or process where the salt from the texturized product or extrudate mixture is removed or reduced.

In some embodiments, initial cooking and/or heating is carried out in a salt solution, then the texturized product or extrudate mixture goes through or is placed in a centrifugation step or process where the salt from the texturized product or extrudate mixture is removed or reduced, and then finally the texturized product or extrudate mixture is placed and heated and/or cooked in a water based no-salt solution. Various embodiments also employ a combination of different cooking times for different stages of the process, different temperatures and different solutions.

In various embodiments, a drying step is added to the processes defined above, by either letting the extrudate sit and drain, or by using a suitable manufacturing drying apparatus. In other embodiments a freezing step is added to the cooked extrudate, either before or after drying depending on the desired effect. In various embodiments, an optional step between the shearing/cutting process and the cooking/heating process may be added where ingredients may be added to the extrudate mixture or HME, these ingredients include and are not limited to spices, spice extracts, salts, oils, flavors, PH agents, preservatives, coloring agents, plants, seeds, animal products etc.

Salts in the solution may be composed of a variety of salt types ranging from sodium-based salts, and including but not limited to table salts, kosher salts, Himalayan pink salts, kala Namak sea salts, infused se salts, Sel Gris, rock salts, flake salts, black or red Hawaiian salts, pickling salts, smoked salts, iodized salts, mineral salts, fine or coarse gained salts, smoked sea salts, organic salt, grey salt, French sea salt, Fleur de Sel, grinder salt, finishing salt etc. Non-sodium based salts may also be used such as potassium salts like potassium chloride. Salt-substitutes such as canallite, kieserite, polyhalite, sylvite, kainite and langbeinite among others may also be used.

Other liquids may be used as a base for, or in the cooking salt solution instead of, or in addition to water, including plant-based bullion with flavors and/or spices/spice extracts and/or conservatives and/or minerals of nutritional value and/or coloring substances, broths and stocks, plant-paste solutions, flavored, enhanced and/or water solutions with PH agents, fat additives and other agents. The salt solution may also be of varying concentrations, with some cooking solutions using a high salt concentration, while others a lower concentration, depending on the desired texture effect as well as the ingredients used in HME/extrudate mixture.

Salts and salt solutions are not generally employed or utilized in the plant-based industry to improve texture, for a variety of reasons, one of which is due to the health implications of adding salt to foods (for example, due to the links of hypertension to high sodium consumption). The general trend in the food industry and especially in the plant-based and health industries is to lower sodium in plant-based foods and proteins. Furthermore, the salt-content of many plant-based mixtures and ingredients, for example pea-based proteins, already have a high sodium content, therefore the addition of salt to these proteins or isolates or plant-based mixtures goes against industry practice.

For all embodiments described in this document, the extrudate mixture/HME may be comprised of varying parts of plant-based proteins and compositions, these include but are not limited to soy protein concentrates, pea protein isolates, rice protein, soy protein isolates, wheat protein, canola protein, sunflower protein, oat protein, potato protein, fava bean or other bean type proteins, mung bean proteins, mycoproteins, chia seed protein, hemp seed proteins, etc. In various embodiments, animal-based milk proteins, whey, casein and other milk proteins and concentrates may be used. In some embodiments animal meats and derivatives may be used as part of the extrudate.

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

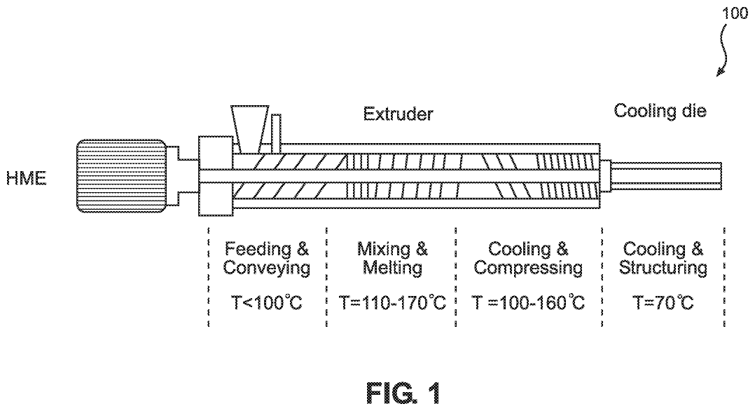

FIG. 1. is a simplified representation of one embodiment of the high moisture extrusion process 100 which is comprised of feeding extrudate material and conveying it into the extruder at under 100° Celsius, then mixing and melting the extrudate mixture at 110-170° Celsius (230-338° F.), followed by cooling and compressing the mixture in the extruder at a temperature 100-160° Celsius (212-320° F.). This schematic drawing is an example of one possible technical relationship/configuration between the extruder and the cooling die and does not purport to represent all other configurations, relationships or sizes of either the extruder, the cooling die or their possible configurations. Finally, the extrudate material is conveyed into the cooling die which cools the extrudate mixture to ca. 70° Celsius (158° F.) at the outlet of the cooling die.

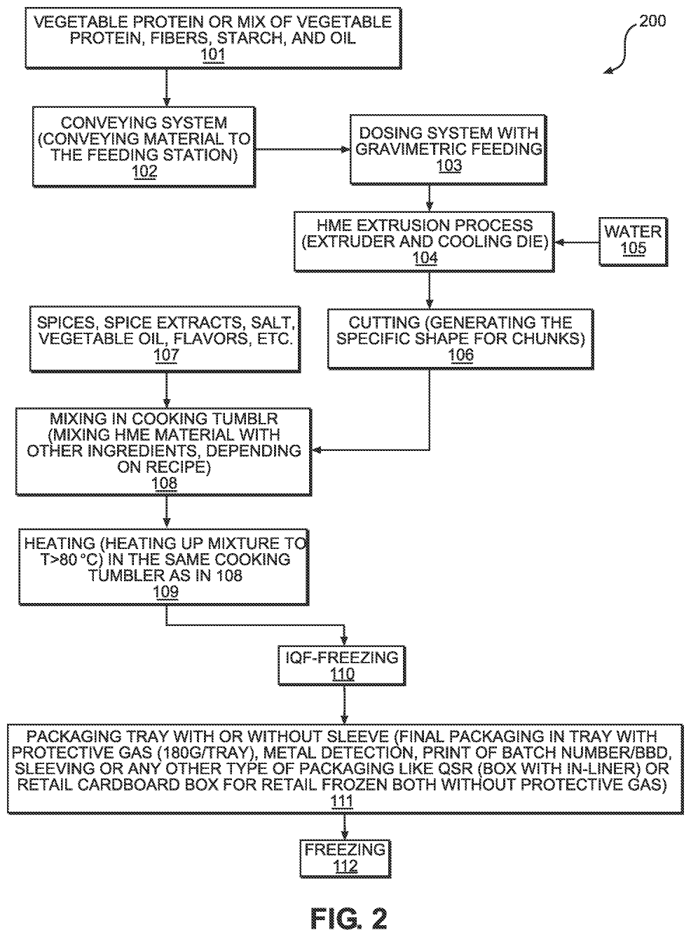

FIG. 2 is a representation of one embodiment of the HME extrusion process and the series of pre-and-post processing steps and processes 200. In this embodiment, materials, and ingredients (preferably but not limited to 1-part soy, and 2-parts water) 101 are conveyed to the feeding station 102 where the ingredients are added individually. The ingredients go through the HME extrusion process 104 where water 105 is added. The materials are mixed and heated and then the extrudate mixture is cooled by a cooling die. After excretion from the cooling die, the extrudate mixture may be cut 106, then mixed in a tumbler 108, which could optionally incorporate a vacuum and optionally mixed with other ingredients. The processes introduced by this application specifically teach adding the extrudate mixture to a salt solution preceding the heating step, this could be done for one example, by or in a cooking tumbler 108 (batch wise or continuously), where the material out of the cooling die is heated 109 or cooked to temperature(s) not higher than 100° Celsius (212° F.). In some embodiments, other ingredients may be added to the tumbler when cooking. Other post-processing steps such as freezing 110 not thoroughly discussed in this paper are also shown. While the figure includes a packaging tray 111 with a sleeve, any type of packaging or packaging tray can be used, not limited to a packaging tray with or without a sleeve or protective atmosphere.

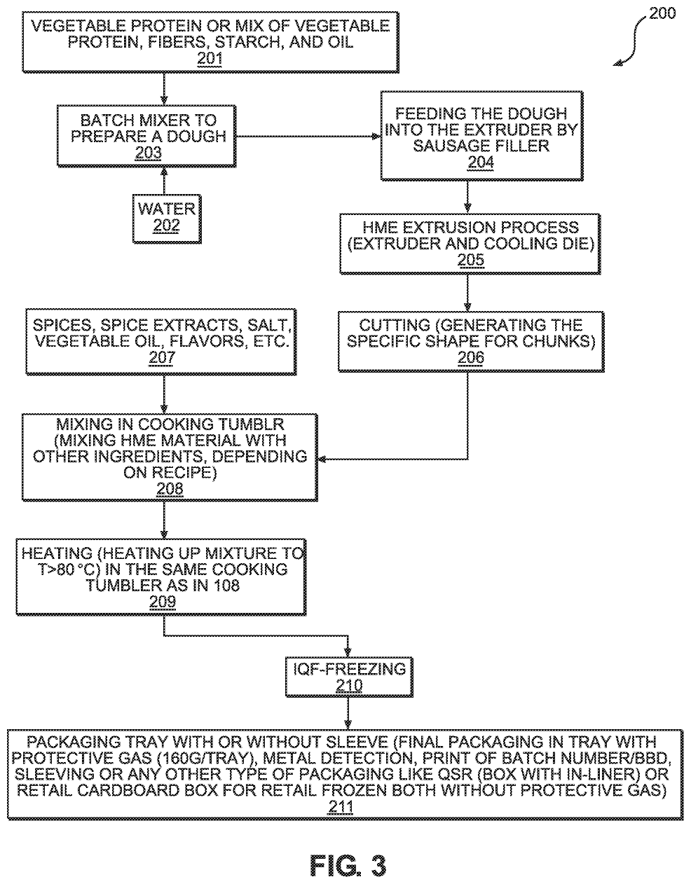

FIG. 3 is a representation of another embodiment of the HME extrusion process as well as the series of pre-and-post processing steps and processes 300. In this embodiment of the processes, a batch mixer is used to mix the plant-based protein and water to form the extrudate mixture (preferably but not limited to 1-part soy, and 2 parts water), which is then fed into the extruder by a sausage filler. The ingredients go through the HME extrusion process where water is added. The materials are mixed and heated and then the extrudate mixture is cooled by a cooling die. After excretion from the cooling die, the extrudate mixture may be cut, then mixed in a tumbler, which could optionally incorporate a vacuum, and optionally mixed with other ingredients. The processes introduced by this application specifically teach adding the extrudate mixture to a salt solution preceding the heating step, this could be done by one example, by or in the cooking tumbler (batch wise or continuously), where the material out of the cooling die is heated or cooked to temperature(s) not higher than 100° Celsius (212° F.). In some embodiments, other ingredients may be added to the tumbler when cooking. Other post-processing steps such as freezing not thoroughly discussed in this paper are also shown. While the figure includes a packaging try with a sleeve, any type of packaging or packaging tray can be used, not limited to a packaging tray with or without a sleeve or protective atmosphere.

FIG. 4. is a flowchart representation of one embodiment of the process 400 to produce muscle-like fibers using plant-based texturized products or extrudate materials/mixtures. After the extrudate mixture leaves the cooling die, shear and/or cut the texturized product or extrudate mixture 410, there is the optional step to add ingredients to the texturized product or extrudate mixture 420 then place the texturized product or extrudate mixture into a salt solution 430, then cook or heat the texturized product or extrudate mixture in the salt solution at no higher than 100° Celsius (212° F.) 440. There is also an optional step of centrifugation (or any other technique to remove the water, e.g., pressing) of the texturized product or extrudate mixture to remove or reduce salt content 450. Some embodiments include an optional step of adding further ingredients to the texturized product or extrudate mixture 460. Finally, optional step to further heat or cook the texturized product or extrudate mixture in another solution for a predetermined period of time at predetermined temperatures 470.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A method for producing a plant-based meat analogue, comprising:
shearing a texturized product, to allow the ingress of fluids;
adding the texturized product to a first salt solution; and
cooking the texturized product in the first salt solution for one or more predetermined time-periods at one or more predetermined temperature ranges.

2. The method of claim 1, further comprising centrifugation of the cooked texturized product.

3. The method of claim 1, where the texturized product is further cooked in a second solution for one or more predetermined time-periods at one or more predetermined temperature ranges.

4. The method of claim 1, where the texturized product is a high moisture extrudate that egresses a high moisture extrusion process.

5. The method of claim 1, further comprising adding an ingredient to the texturized product before placing the texturized product in the first salt solution.

6. The method of claim 1, wherein the one or more predetermined temperature ranges is no higher than 100 degrees Celsius.

7. The method of claim 1, further comprising using a batch mixer to mix plant-based protein and water to form extrudate mixture that is fed into an extruder to form the texturized product.

8. The method of claim 7, wherein the extrudate mixture is approximately 1 part soy and approximately 2 parts water.

9. The method of claim 8, further comprising adding water during extrusion.

10. The method of claim 9, further comprising mixing and heating the extrudate mixture.

11. The method of claim 10, further comprising cooling the extrudate mixture by a cooling die.

12. The method of claim 10, further comprising adding the extrudate mixture to a salt solution preceding the heating.

13. The method of claim 11, further comprising cutting, mixing and incorporating a vacuum after the extrudate mixture is excreted from the cooling die.

14. The method of claim 13, further comprising adding another ingredient to the extrudate mixture.

15. The method of claim 14, further comprising freezing the extrudate mixture.

16. The method of claim 7, further comprising feeding the extrudate mixture into the extruder at approximately under 100 degrees Celsius.

17. The method of claim 10, further comprising the heating of the extrudate mixture at approximately 110 degrees Celsius to approximately 170 Celsius, followed by cooling and compressing the extrudate mixture in the extruder at a temperature of approximately 100 degrees Celsius to approximately 130 degrees Celsius.

18. The method of claim 11, wherein the cooling of the extrudate mixture by the cooling die is at approximately 70 degrees Celsius at an outlet of the cooling die.

19. A plant-based meat analogue comprising a non-animal protein, a flavor enhancer, a preservative, a PH agent, a color additive, a fat, a bonding agent, the plant-based meat analogue having long meat-like fibers in parallel placed on top of each other and produced by having a laminar flow of an extrudate mixture in a cooling die of an extruder.

20. The plant-based meat analogue of claim 19, wherein a thickness of the long meat-like fibers is approximately 20 millimeters to approximately 25 millimeters.
